(19) United States
(12) Patent Application Publication
(10) Pub. No.: US 2009/0012880 A1
(43) Pub. Date: Jan. 8, 2009

(54) User Interface For Creating and Displaying Digital Signage

(76) Inventor: Lucio Tortola, Windsor (CA)

Correspondence Address: MCANDREWS HELD & MALLOY, LTD, 500 WEST MADISON STREET, SUITE 3400, CHICAGO, IL, 60661, US

(21) Appl. No.: 12/138,091

(22) Filed: Jun. 12, 2008

Related U.S. Application Data
(60) Provisional application No. 60/943,725, filed on Jun. 13, 2007.

(51) Int. Cl. G06Q 30/00; H04L 9/32; G06F 17/00; G06F 3/048; G06F 17/50; G06G 7/62

(52) U.S. Cl. 705/27; 726/5; 715/202; 703/17

(57) ABSTRACT

A digital signage network is provided comprising a browser based user interface, a management center, at least one media player and at least one digital display unit. In certain embodiments the browser based user interface allows for a user to create, manage and edit a digital scheduling program via the digital signage network. In certain embodiments the browser based user interface comprises a template community feature, a photo editor feature, a news management feature, a logo manager feature, a video playback feature, a live access feature, a network player status viewing feature, a granular scheduling feature and a dynamic template feature.

### CROSS-REFERENCE TO RELATED APPLICATIONS

This application makes reference to, and claims priority to, U.S. provisional application Ser. No. 60/943,725 filed Jun. 13, 2007.

### FIELD OF THE INVENTION

Certain embodiments of this invention relate to digital signage. More specifically, certain embodiments of the invention relate to a browser based user interface for enabling a user to design and customize a digital sign display.

### BACKGROUND OF THE INVENTION

Digital signage is a network of electronic displays that can be remotely managed, designed and controlled for display at a plurality of locations. Typically a digital signage network will focus on merchandising, marketing or advertising, though various other uses for digital signage exist. For example, digital signage may be used to display the status of flights in an airport, or to display stock prices, news headlines, sports updates, etc. in a waiting room or hotel lobby.

One benefit of digital signage is that an advertiser's message can be presented to a captive audience where viewers have limited other stimulus to hold their attention. For example, customers waiting in line at a supermarket will likely pay great attention to advertisements on a digital display to pass the time of waiting. Also, because consumers waiting for service often have distorted perceptions of elapsed time, digital signage can also improve a waiting consumer's experience. Thus, a strategically placed digital signage display near an area where viewers are likely to be waiting for a service (e.g., a check out line in a supermarket) can target an advertiser's message to this captive audience while simultaneously reducing the negative perception caused by time spent waiting in line.

Digital signage systems can present advertising campaigns and other messages at the critical point of decision at a preselected place and moment, to the right audience. Accordingly, the benefits of digital signage also include an increase in product knowledge and brand awareness among consumers and the ability to influence consumer behavior, potentially resulting in an increase in sales.

An important feature of a digital signage system is the ability to create, modify and control the content that forms the media projected on the display units. Digital signage software, is therefore a valuable component of a digital signage network. Software utilized in digital signage may comprise of media playing software that serves the content to the display units; content management software that controls the scheduling and distribution of content; and device management software that monitors the network. Content may be controlled both centrally and regionally. Because the content on the display of digital signage is crucial as to time and location of display, it is valuable to allow users to change or modify the displays promptly and frequently, so that the proper messages are delivered to the proper viewers at the proper moment.

Traditional digital signage software is bulky, complicated, expensive, and requires a great deal of training and graphical design knowledge in order to be fully utilized. Therefore, there exists a need for digital signage software that provides users with freedom to create, control and modify the content of the digital signage network, and to do so easily, without requiring incorporation of additional programs and/or devices, or an extensive knowledge of graphical design or computer programming.

Additionally, there exists a need for interactive software that allows a user to view a simulated view the digital signage display in a particular environment.

### BRIEF SUMMARY OF THE INVENTION

A digital signage network is provided comprising a browser based user interface for designing and controlling content for a digital signage network. The browser based user interface comprises a template selection feature that provides an array of dynamic advertising content templates for the user to choose from, a photo editor feature comprising a cropping function, an effect modification function and a text overlay function. The browser based user interface further comprises a news management feature for hosting external internet feeds, a logo manager feature, a network player status viewing feature, a website integration feature, an automatic update feature, an automatic activation feature and a composite video display feature. The provided digital signage network allows a user without a high level of knowledge and sophistication in the field of graphical arts to easily and efficiently create and control a digital scheduling program for display over at least one display unit through a digital signage network.

A digital signage network for displaying a digital scheduling program. In certain embodiments, the digital signage network comprises a browser based user interface accessible on a computer work station for designing and editing the digital scheduling program. In certain embodiments, the browser based user interface has a template community feature providing an array of advertising content templates for user selection; a photo editor feature for modification of electronic images. The photo editor feature may provide a cropping function, an effect modification function and a text overlay function. The interface may also have a news management feature for providing external internet feeds for display on the digital scheduling program. A logo manager feature provides access to an array electronic logo images. A dynamic template feature enables a user to create dynamic content on the digital scheduling program, and a granular scheduling feature can schedule the display of the digital scheduling program according to user specifications.

In certain embodiments, the digital signage network has a management center for managing the display of said digital scheduling program. The network may also have one or more media players for operating the digital scheduling program. The digital scheduling program may be displayed on at least one digital display unit, such as a monitor, a LCD or plasma television, or a projector, for example.

A user operating the browser based user interface can generate and edit the digital scheduling program according to user specifications. The management center manages the display of the digital scheduling program according to user specifications provided via the browser based user interface. The digital scheduling program can be operated by media players for display on the display units.

A high definition signage simulator is also provided comprising a simulated digital signage display module creation feature; a background scene selection feature, a simulated digital signage display module locator function and a structural image producing feature.

### BRIEF DESCRIPTION OF THE DRAWINGS

FIGS. 1-3 are diagrams of digital signage networks in accordance with embodiments of the presently described technology.

FIG. 4 depicts screen shots of the operation of a playlist management and a media management features via a browser based user interface for creating a digital scheduling program.

FIG. 5 depicts screen shots of the operation of a media management feature and a media creation feature via a browser based user interface for creating a digital scheduling program.

FIG. 6 depicts screen shots of the operation of a live access feature and a via a browser based user interface for creating a digital scheduling program.

FIG. 7 depicts screen shots of the operation of a user management and user creation features via a browser based user interface for creating a digital scheduling program.

FIG. 8 depicts screen shots of the operation of logo management feature via a browser based user interface for creating a digital scheduling program.

FIG. 9 depicts screen shots of the operation of a location management feature and a technician management features via a browser based user interface for creating a digital scheduling program.

FIG. 10 depicts screen shots of the operation of a technician management and playlist creation features via a browser based user interface for creating a digital scheduling program.

FIG. 11 depicts screen shots of the operation of a playlist management feature via a browser based user interface for creating a digital scheduling program.

FIG. 12 depicts screen shots of the operation of a background editing feature and a playlist importing feature via a browser based user interface.

FIGS. 13 and 14 depict screen shots of the operation of a template management feature via a browser based user interface.

FIGS. 15 and 16 depict screen shots of the operation of a dynamic template management via a browser based user interface for creating a digital scheduling program.

FIGS. 17-25 depict various screenshots of the high definition signage simulator program.

### DETAILED DESCRIPTION OF A PREFERRED EMBODIMENT

The present disclosure describes novel systems and methods for managing a digital signage system. Certain embodiments of the present technology present a digital signage system providing a user interface that offers user applications for creating, modifying and operating a digital signage display, or displays. Certain embodiments present methods and systems for controlling a digital signage network that is managed through a web browser. Certain embodiments provide a simulated digital signage display program that allows users to simulate a digital signage display upon a background image.

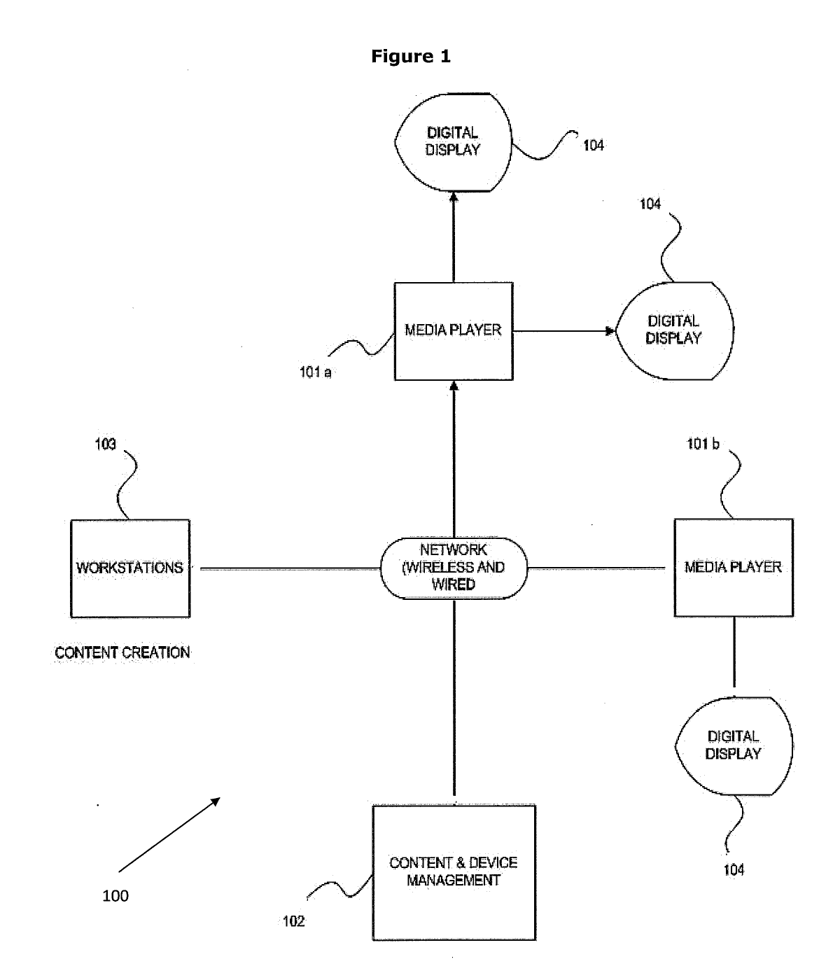

Digital signage networks generally comprise centrally managed playback devices or media players that serve content to displays units such as monitors, televisions or any other medium capable of producing electronic imagery. FIG. 1 depicts an example embodiment of a digital signage network 100 in accordance with at least one embodiment of the present technology.

Content for a digital signage network can be created, modified and controlled via content creation software located on one or more computer workstations connected to the digital signage network, either locally or via the internet. For example, as depicted in FIG. 1, content may be generated via a content creation work station or work stations 103.

As depicted in FIG. 1, a digital signage network 100 connects media players 101, a content device management console 102 and a content creation console 103. Digital display units 104 are connected to a particular media player 101, where each media player 101 is capable of servicing several display units 104. To generate high resolution displays, the digital display units 104 can be a high definition flat screen display unit such as a plasma or LCD high definition television; however, the display units 104 can be any means of displaying digital content. For example, display units 104 may be LCD monitors, DLP television displays or any form of television, or projectors and screens.

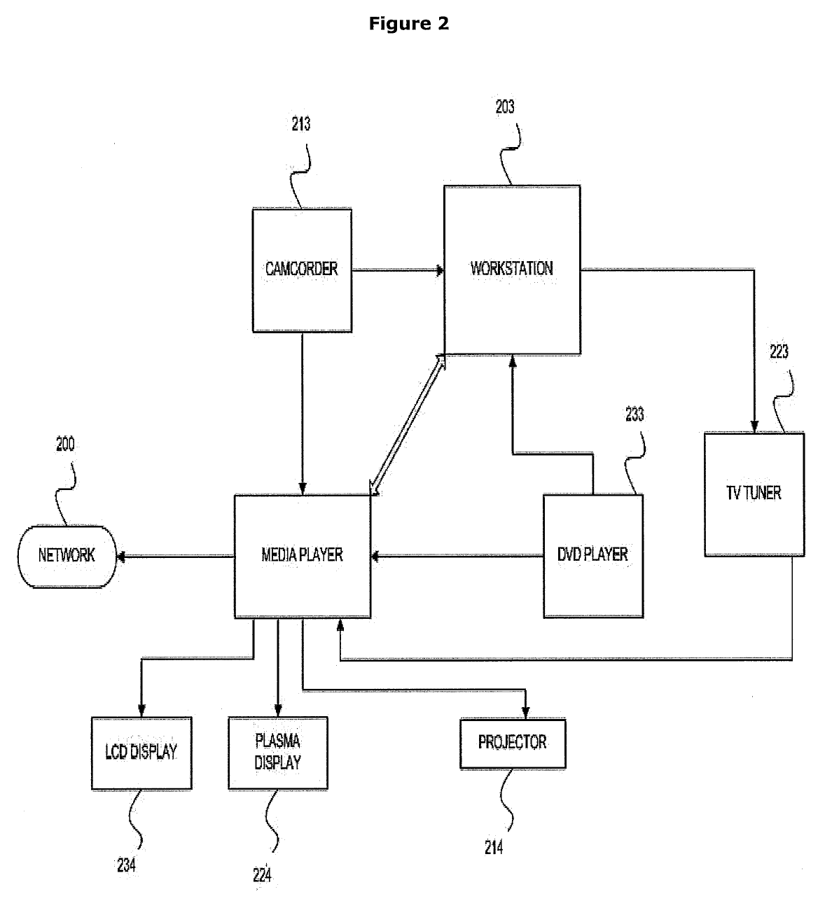

FIG. 2 displays another embodiment of a digital signage network 200. A media player 201 connected to a network 200 and servicing a variety of media display systems such as a projector 214, a plasma display 224, and an LCD display unit 234. Additionally, several inputs may provide digital content to the digital signage network. FIG. 2 depicts media player 201 as receiving a variety of media inputs such as a camcorder 213, a TV tuner 223 and a DVD player 233. The media player may be connected to a work station 203 that manages the content schedules and may edit media generated by the input devices. The digital display network can provide support for a variety of video aspect ratios. For example, the digital signage network provides support for a widescreen 16:9 mode, a standard 4:3 mode, and a vertical 9:16 poster mode.

Referring again to FIG. 1, content is delivered by media players 101 to be displayed on display units 104. A particular media player 101 may deliver content to a plurality of display units 104, providing an identical schedule of content to each display unit 104 which may be located in multiple locations. A plurality of media players 101 on a particular digital signage network 100 allows for multiple schedules of content to be provided to various display units 104 throughout the network 100. For example, a digital signage network 100 used in a department store may have a first media player 101 that is located in the men's apparel department deliver a particular schedule of advertising content that is geared towards men's clothing, a second media player 101 that delivers advertising content geared towards women's clothing to display units located in the women's apparel department, and a third media player 101 that delivers advertising content geared towards cooking and baking to display units located in the housewares or kitchen accessories department. The content and device management console 102 manages the delivery of each schedule of content delivered to media players throughout the network. Each particular schedule of content is designed, modified and controlled via the content creation console 103.

The digital signage network 100 may be a small network that services a particular geographic location, such as a department store or a car dealership, or it may, via use of the internet, provide a larger network that services a variety of lactations geographically distinct from each other.

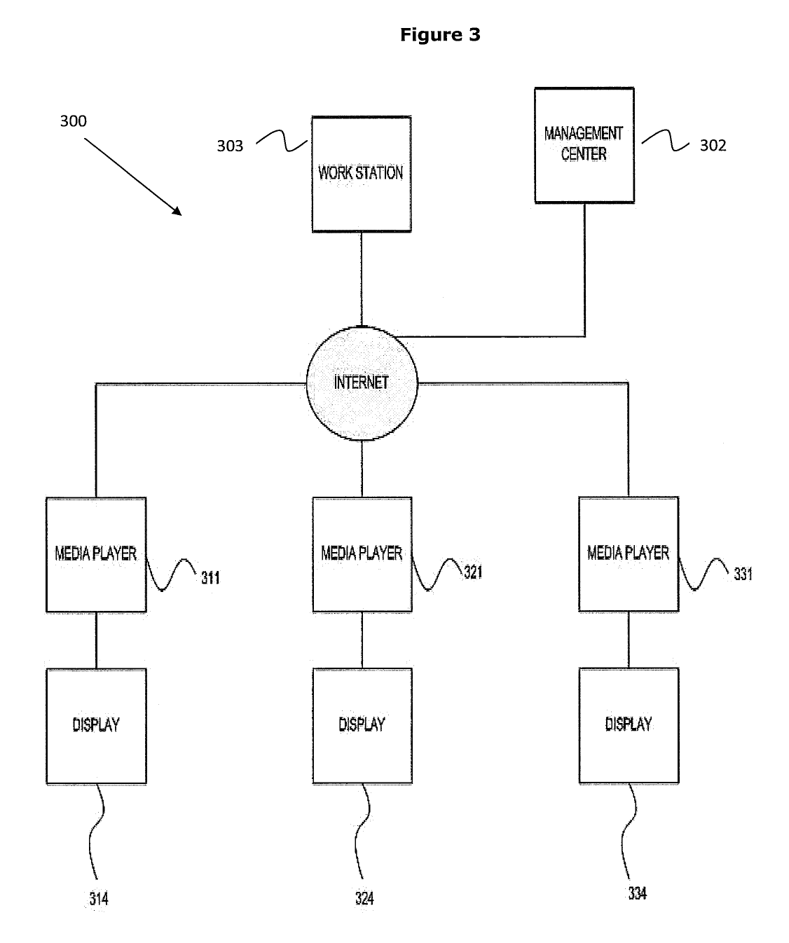

FIG. 3 demonstrates the location of multiple media players 301 at various locations connected to a network via the internet. Three display units 314, 324 and 334 at three locations are connected individually to media players 311, 324 and 334, respectively, each of which may display content distinguished from or identical to that of other media players throughout the network 300. For example, a franchise fast food restaurant may have a digital signage network that, through use of the internet, provides an identical schedule of content to each franchise unit world wide to provide advertising and entertaining media to customers waiting in line or dining within the restaurant. Additionally, various schedules of content may be provided throughout the network to provide a different schedule geared to particular establishments based on, for example, geographic location or restaurant size. The control of the content can be managed via the management center 302, and can be created and modified via a workstation 303 or work stations connected to the network via the internet.

Referring again to FIG. 1, a content creation console 103 designs, creates, modifies and controls each schedules that are displayed via media players 101 throughout the digital signage network 100. Content creation console 103 may comprise a single computer, or a network of computers, each of which is capable of accessing a browser based user interface software program that controls the content of each schedule delivered to the media players 101 on the digital signage network 100. The content creation console 103 computers may be connected locally to the network, or may access the network through an internet connection. A browser based user interface software program provides assistance to users to design and maintain schedules of content by providing various content addition and editing features.

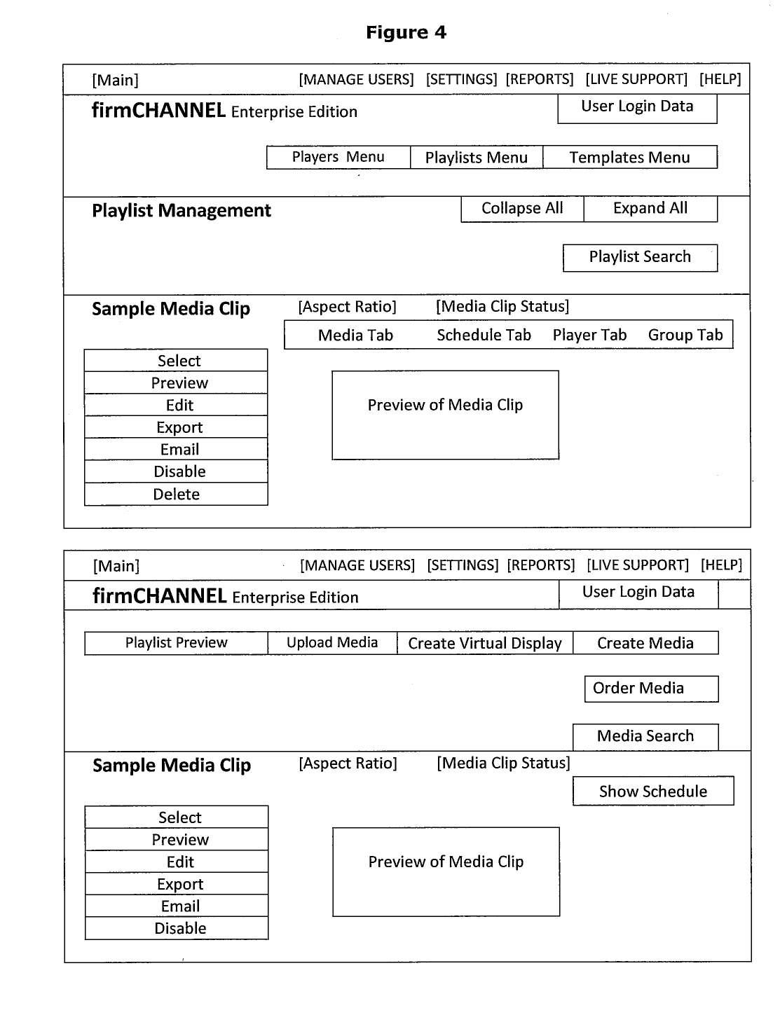

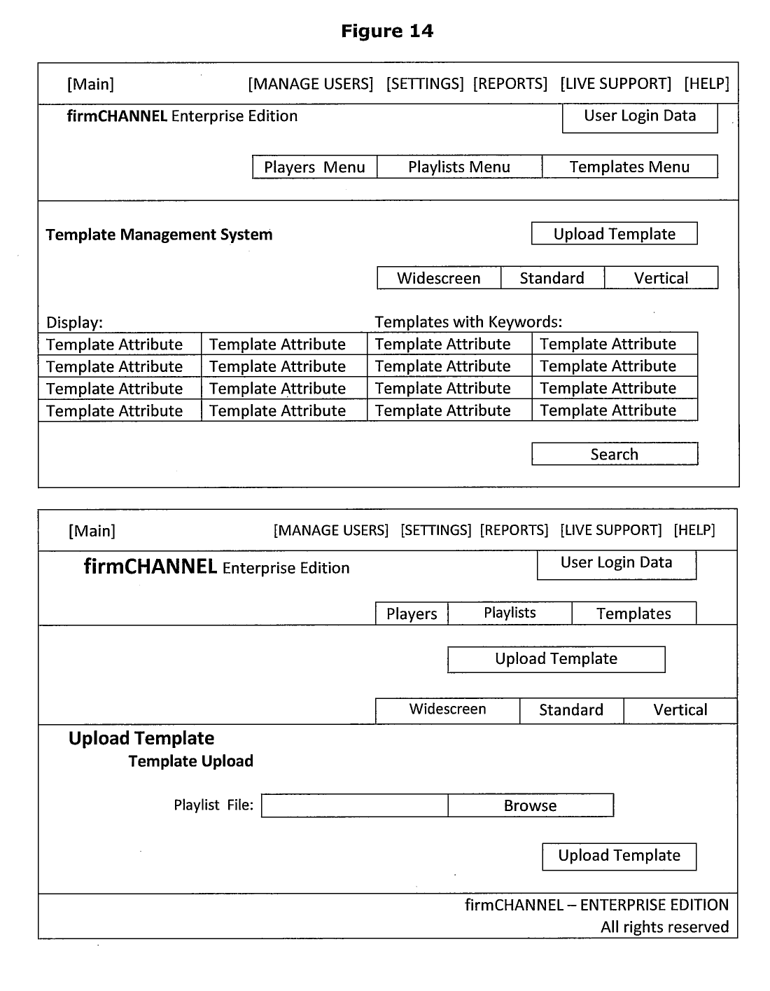

FIGS. 4-16 depict screen shots of the browser based user interface performing functions of the interface software. FIG. 4 displays screen shots of a user operating the playlist management feature of the application. A user may add content in a fashion similar to that method used in slide show presentation software such as Microsoft PowerPoint®. A variety of templates are available for the user to select to begin design of the desired content. Content or media is created by selecting a template and inserting text, images, videos or other media that is desired to be displayed. For example, a user may select a template that provides a location for an image on the right side of the display and text on the left side, with a banner headline, a website on the bottom left and a logo on the bottom right as depicted in FIG. 4. Other templates offering other designs, layouts and features are also available for selection at the user's preference. Additionally, a dynamic template feature allows a user to customize the template structure and is described infra. The browser based user interface may further provide a template community feature. The template community feature allows the user to access previously established advertising and media templates to which content may be easily added in a browser based setting.

The browser based user interface may also provide a variety of software programs and media features that allows the users to edit media and content without incorporating other software programs. A photo editing program allows users to import and modify images. The photo editing feature may provide features allowing users to crop, resize, rotate and flip the image. The photo editing feature may also provide all features common to many photo editing programs. For example, the user will be able to add text to an image, edit and restore add effects such as color restoration, blurring, blending and deleting, and the user will be able to overlay multiple images to create a scene or image as desired.

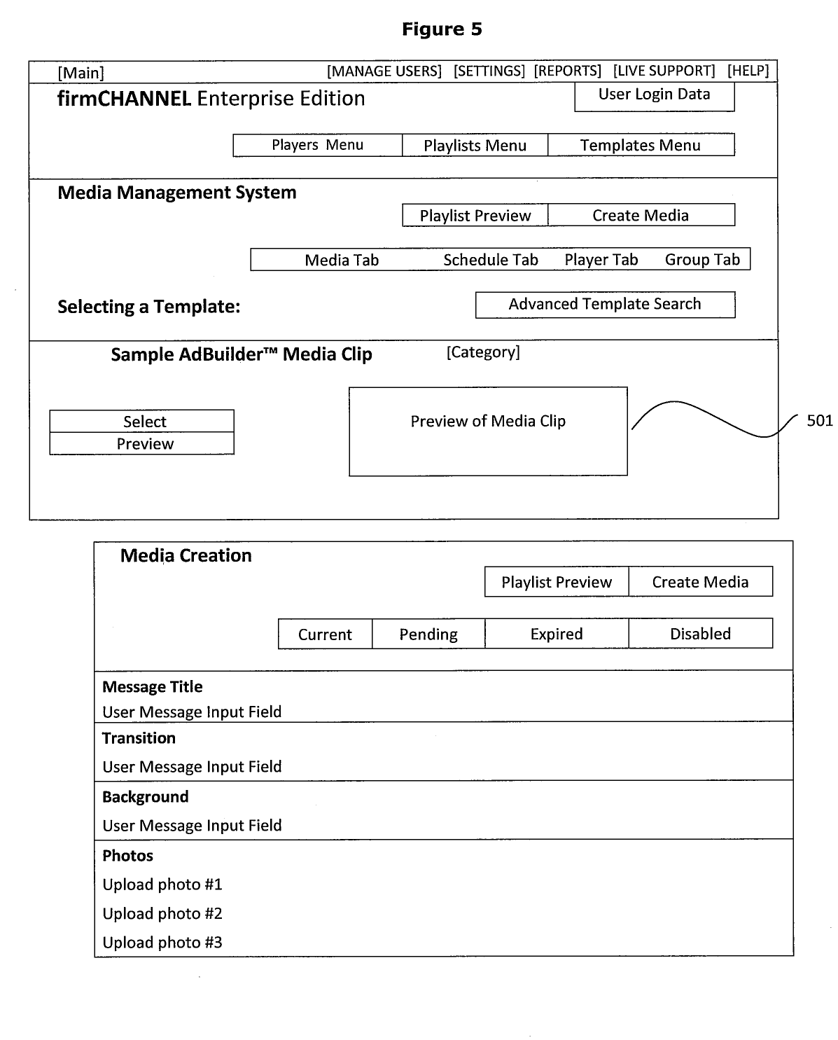

FIG. 5 depicts a sample screen shot of a user operating a media management system feature of the browser based user interface. In the media management system, a user may select a template, such as an image 501, to use as the background for a digital display. The user may also input a message title, select message transitions and background images.

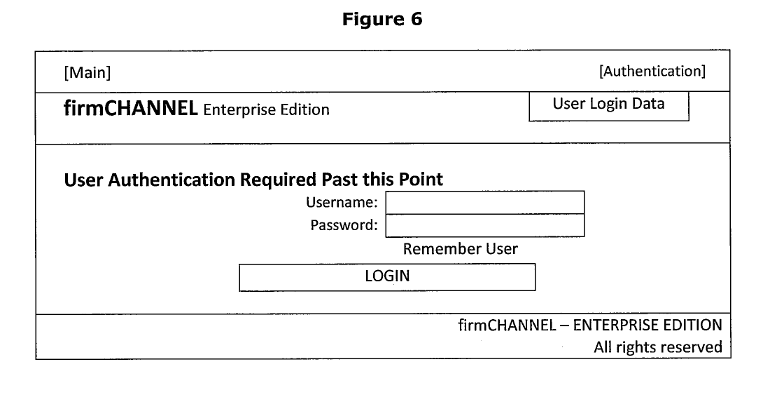

FIG. 6 depicts an exemplary screen shot of a live access feature, or a user authentication feature of the browser based user interface. For example, a user seeking to modify the digital signage content may be required to provide a username and password through the authentication feature.

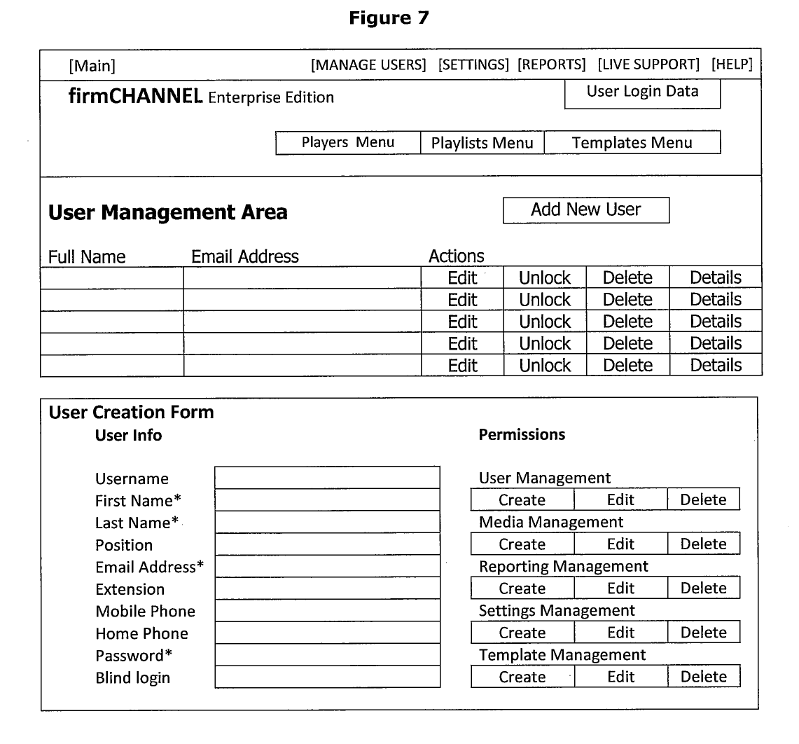

FIG. 7 depicts an exemplary screen shot of a user management feature of the browser based user interface. The user management feature allows an administrator to manage permissions for a plurality of users. For example, a digital signage network set up for a restaurant having several locations may grant each restaurant manager access to the display network only for that manager's restaurant, thereby preventing restaurant managers from modifying content at other restaurant locations.

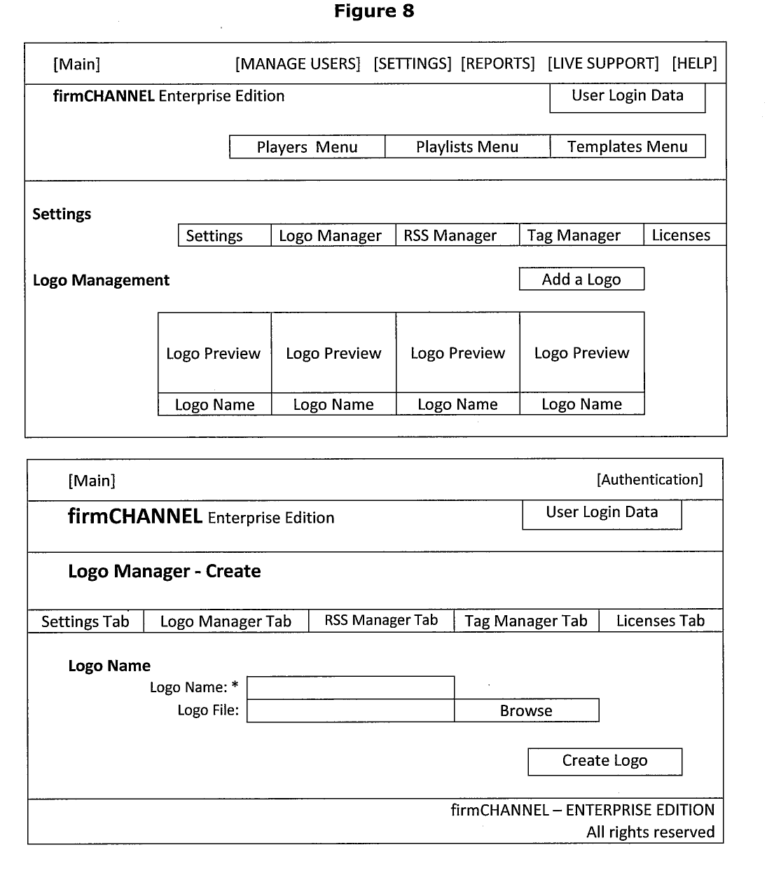

Referring to FIG. 8, the browser based user interface may also provide a logo manager feature. The logo manager allows a user to save and store multiple corporate logos and designs for quick and easy access where those logos are used frequently in displays. FIG. 8 displays an example of a particular user's logo manager feature. To operate the logo manager feature, the user may select the Logo Manager tab on the browser based user interface. Logos that the user has used and stored in the past appear for the user's selection. Once the user selects one or more logos, that logo is added to the current display that the user is creating or modifying. When new logos are obtained, either from the internet, the photo editing feature or some other source, they may be added and maintained within the user's logo manager for future access and use. For example, a user may create advertisements that commonly include items produced by Company A. Such a user may use the logo manager feature to quickly access a database of all the logos used, and sort the logos by those applicable to Company A for fast and efficient production of the desired logos.

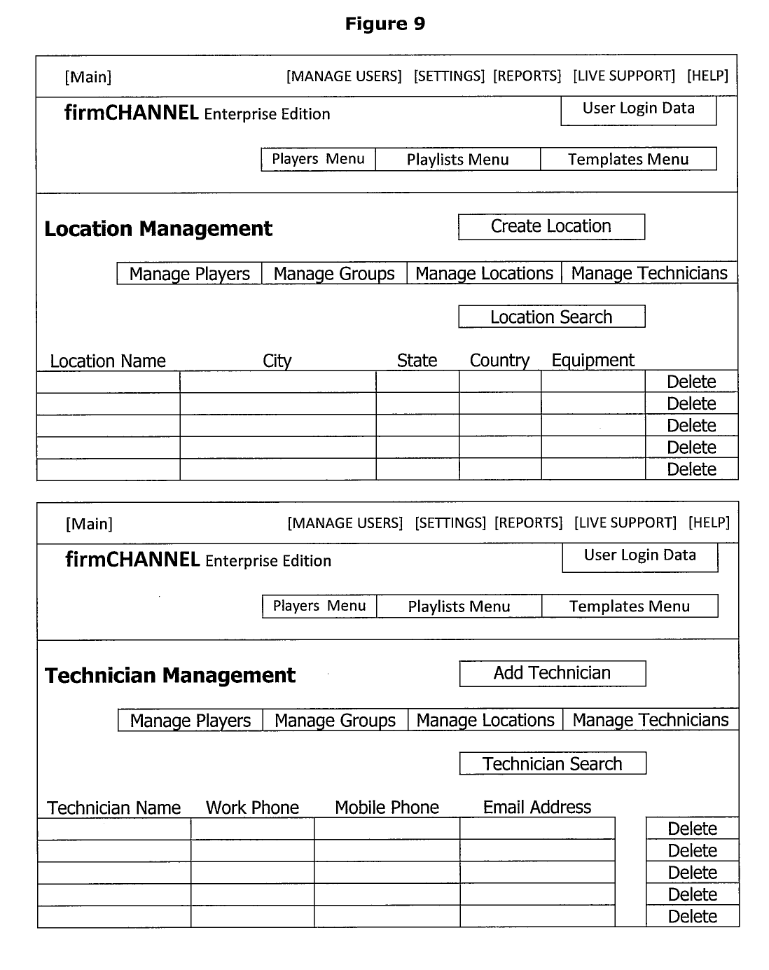

FIG. 9 depicts an exemplary screen shot of a location management feature and a technician management feature of the browser based user interface. For example, a digital signage network having displays at multiple locations (Windsor, Toronto, Spain, etc) may be managed to edit and disable the content provided at each location. Additionally, the locations may be deleted from the system.

The technician management feature provides control for adding, deleting and modifying permissions and information for technicians having access to the system.

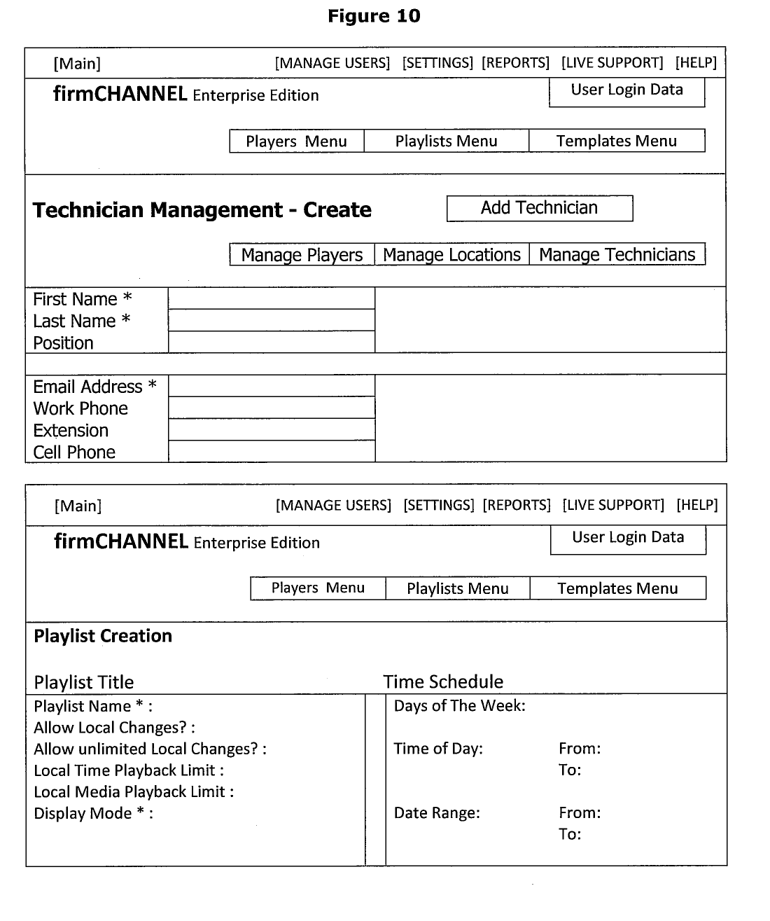

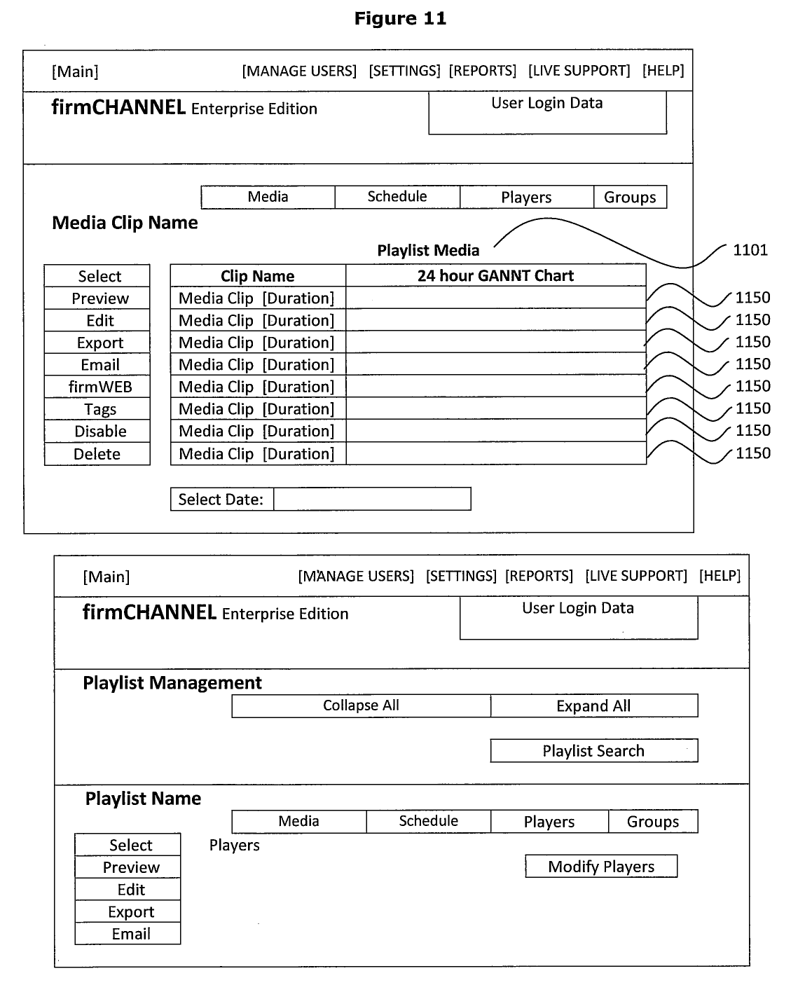

FIG. 10 provides an exemplary screen shot of a technician management feature and a playlist creation feature of the browser based user interface. Using the playlist creation feature, a playlist of media content may be created, and managed to operate at particular times of the day, days of the week, and dates of the year. For example, a holiday playlist may be managed to play only during the month of December, or an evening playlist may be managed to begin running during the hours of 6 P.M. until midnight on weeknights. FIG. 11 further depicts exemplary screen shots of the playlist management feature. The playlist 1101 may be comprised of a plurality of media snippets 1150, each containing different media of various lengths. For example, one media snippet may display an advertisement for laundry detergent and be on display for 15 seconds, and the next snippet on the playlist may be for a sale on toothpaste and be on display for 20 seconds.

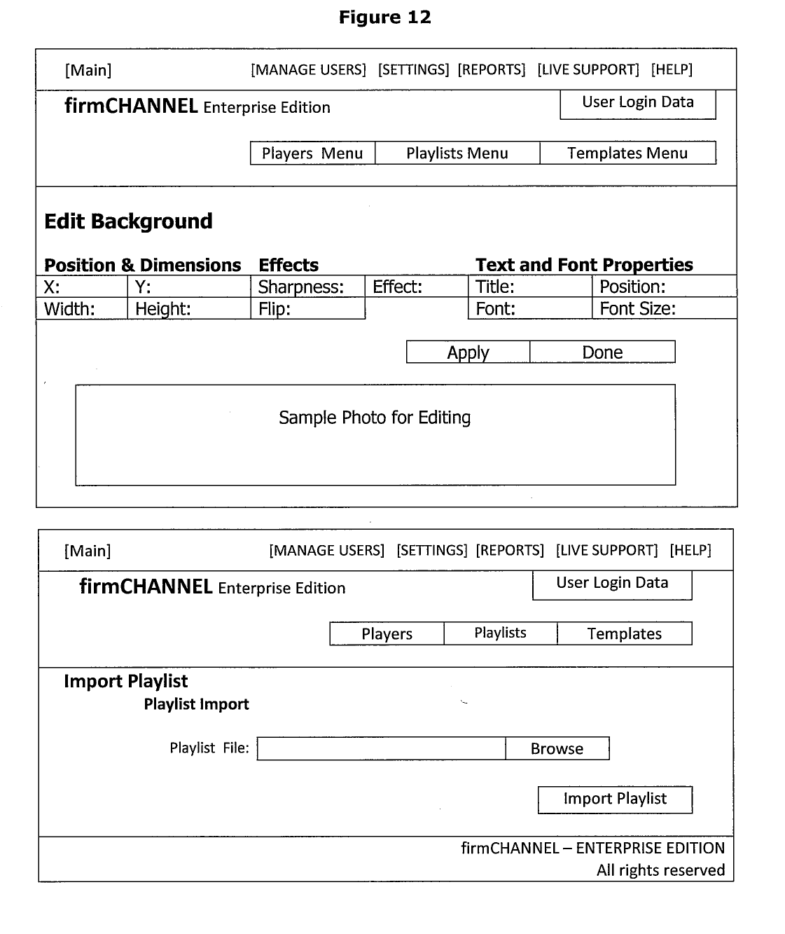

FIG. 12 provides an exemplary screen shot of a background editing feature and a playlist importing feature of the browser based user interface. The size, position, effects, text and font properties ma be edited for one or more media snippets via the background editing feature. The playlist importing feature allows a playlist to be imported from a local or remote location to the work station on which a user is operating the browser based interface.

Additionally, the browser based user interface may provide news manager feature. This feature allows the user to create content that connects to feeds providing information over the internet. For example, the user interface will allow a user to insert a scrolling ticker or a window that provides information that may be updated via the internet. For example, the news manager feature may provide a scrolling ticker that runs below an advertisement message that provides up to the minute status of stock prices, weather, sports scores or news headlines along side a display.

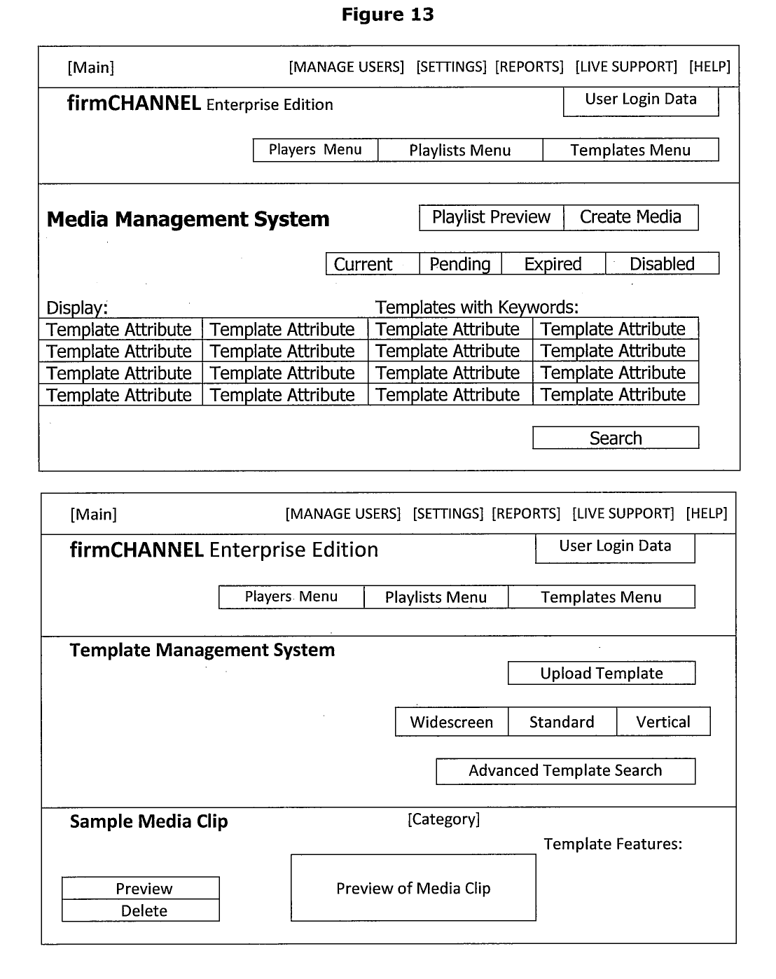

FIG. 13 depicts an exemplary screen shot of a template management feature of the browser based user interface. The template management feature allows a user to access various templates that offer preselected locations for various advertising images or texts. For example, a user may select a template via the template management feature that provides a space for a headline text at the top of the screen, a space for an image (e.g., a product being advertised) at the right of the screen, and a space for text to the left of the image.

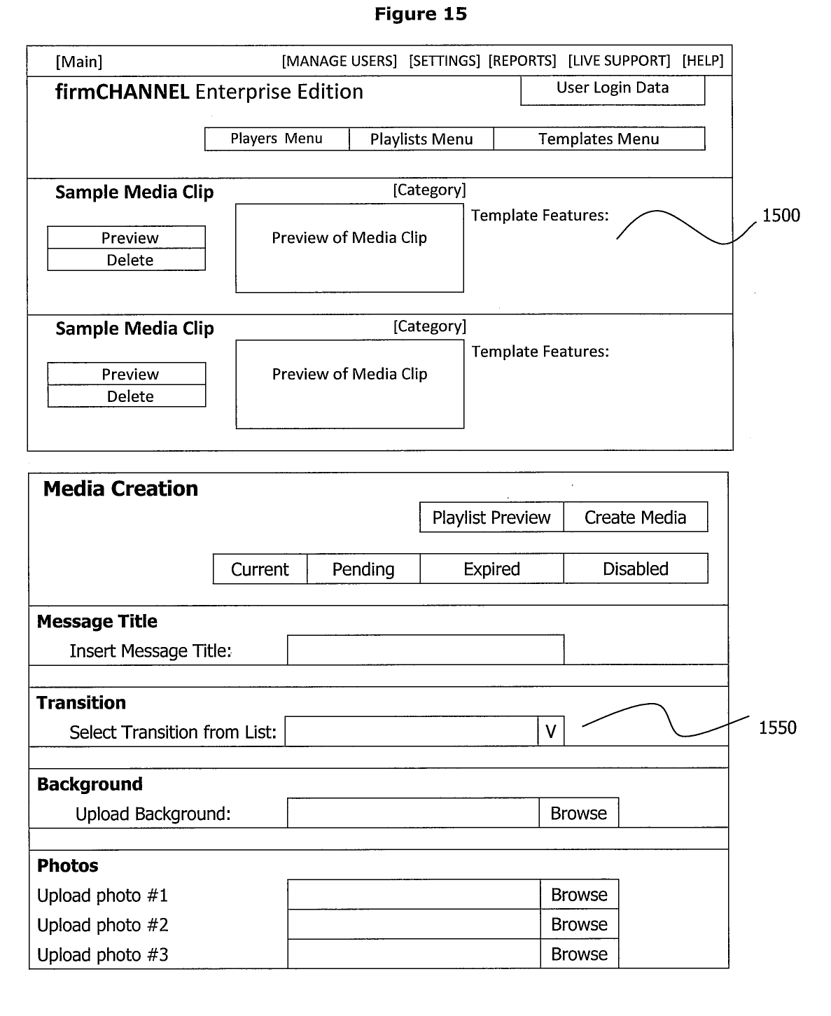

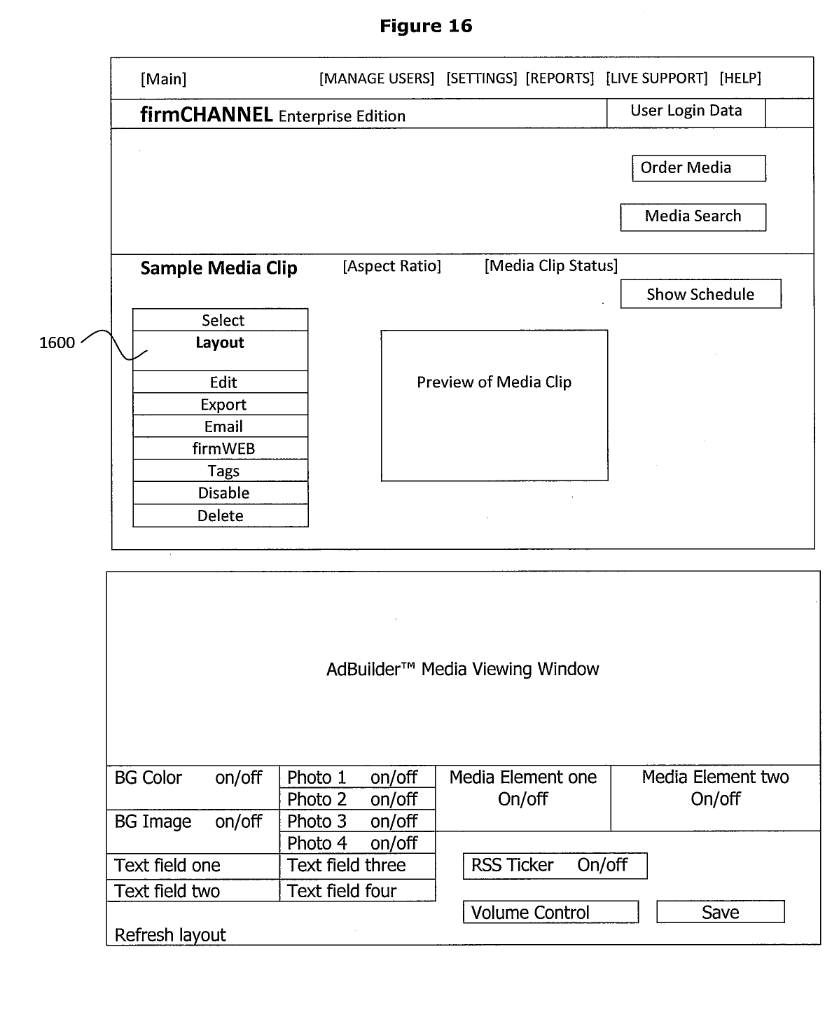

The browser based user interface may also provide a dynamic template feature. FIGS. 15 and 16 demonstrate screen shots of the application in use as a user creates a dynamic template. FIG. 16 depicts a user selecting a “Dynamic” option from a list of templates previously designed and stored within the program. The dynamic template feature allows a user to select the features, functions, design and layout of the templates. For example, FIG. 15 depicts a user selecting a dynamic template utilizing the template features 1500 of photos, a background image, a company logo and a flash video.

The dynamic template feature may also provide a user the ability to select media, texts and effects to be added to the dynamic template. For example, FIG. 15 depicts a screen shot of a user inserting a message title and applying a “fade” transition effect 1550 to the title. FIG. 16 depicts a screen shot of a user selecting and modifying a particular layout 1600 of a digital signage display.

The user interface may also provide a video playback feature. The browser based user interface can connect to a video source via a cable television, an S-video connector, or a composite video connector. The browser based user interface may also support digital video formats. For example, the browser supports Flash9 and utilizes MPEG-1, MPEG-2, MPEG-3, DivX, Xvid, Microsoft WMV, AVI, and Apple Quicktime video programs. Further, the browser based user interface may also include a video capture feature that allows a user to connect a video source such as a video camera via a connector such as an S-video cable, or a composite video connector. The video playback feature also provides the ability for a user to create schedules that provide video content. For example, a user may create a digital signage schedule for display in a hospital waiting room that provides entertainment in the form of television programs, or a user may provide video content in the form of cooking programs for display in a kitchen, cutlery or grocery department of a store.

The browser based user interface may also provide a live access feature. The live access feature allows a user to authenticate and access the creation content console remotely using the internet. The live access feature therefore allows a user to play and view the content currently on display of any display unit from a remote location. Additionally, the live access feature allows the user to access the status of each media player on the digital signage network through the browser based interface at any location via the internet Via the live access feature, a user may view content schedule currently on display of any media player on the digital signage network, as well as statistical information such as memory utilization, hard disk space, response time, and detected problems. For example, a user may, via the internet, remotely view the schedule on display at a grocery store location across the country, view the memory utilization of that display location, and modify the display schedule. The live access feature also allows the digital signage network user to access updates to the player systems via the internet. Additionally, the live access feature allows for users to activate and register their products remotely via the internet.

The live access feature may be featured on a website and rendered in real time by an enterprise server. The media depicted on this stream may be created and scheduled by any authenticated user via a web browser. The content and media on this stream may be placed directly into a vast array of professional designed templates, or created via the browser based user interface. The browser based user interface may provide the power to create ad agency style media that the user may fully control on a digital signage system and/or an internet website.

The browser based user interface may also provide a granular scheduling feature. The browser based user interface allows content playlists and media content to be scheduled to a user's desired specifications. For example, a content playlist can be scheduled to play at specific times of the day, particular days the week or particular times of the year to relate to a target audience. Further, schedules may be stacked to produce complex playback timetables such that once a playback timetable is established, no further maintenance is required of the user until the timetable has run its course. For example, a user may create several schedules that operate at particular times of day, particular days of the week and particular times of year such that several years worth of media content may be created at one sitting.

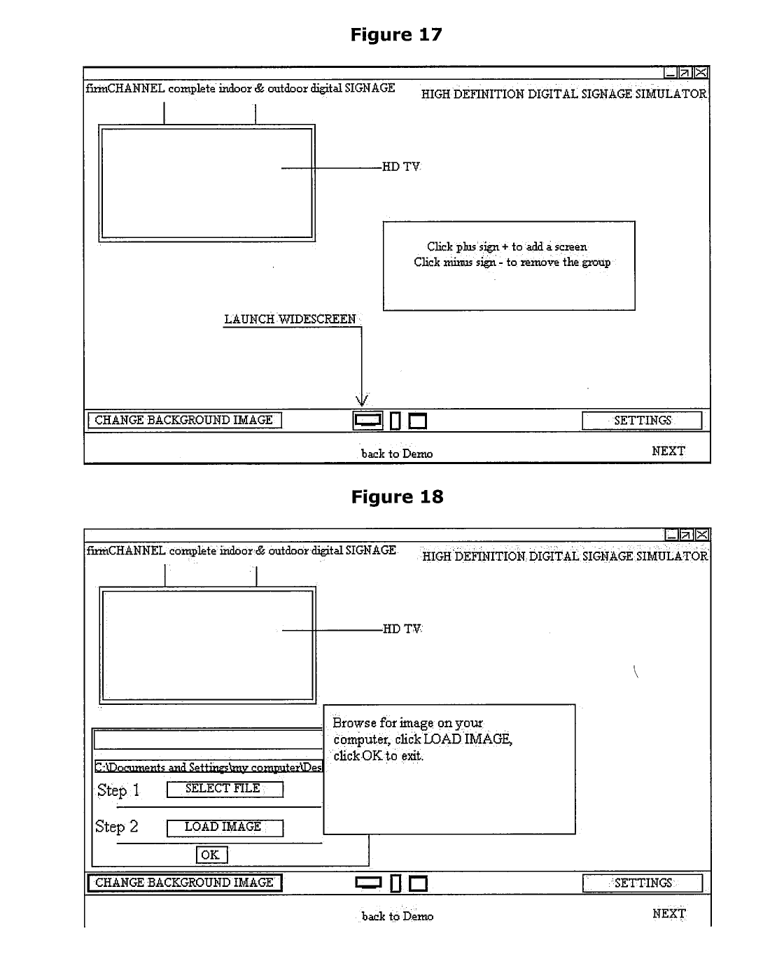

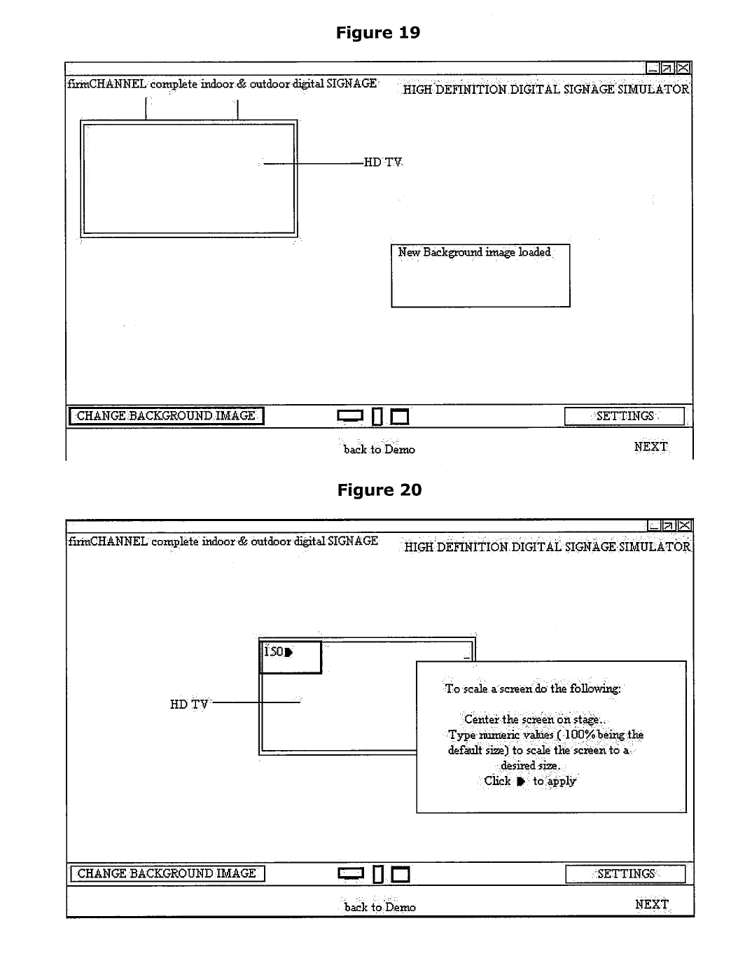

In another embodiment of this invention, a high definition signage simulator is provided as depicted in FIGS. 17-25. The high definition signage simulator is a software program that provides the user with the ability to display a simulated digital signage display against a selected background image, and to move the display about in three dimensions. For example, FIG. 17 depicts screen shots of the high definition signage simulator launching a simulated digital signage display. The simulated digital signage display module is a floating, movable unit that displays a schedule of content created using the browser based user interface. FIG. 18 depicts the high definition signage simulator with a simulated digital signage display upon a backdrop image. A user may wish to load an image of the location where the digital signage display will be located. FIG. 19 displays a screen shot of the high definition signage simulator where a simulated digital signage display has been submitted upon a background image of the outside of a storefront. In this embodiment the user has the option to resize, rotate and relocate the position of the simulated digital signage display module to simulate various signage locations in an actual environment. FIG. 20 depicts a screen shot offering a user an option of determining the size of the simulated digital signage display.

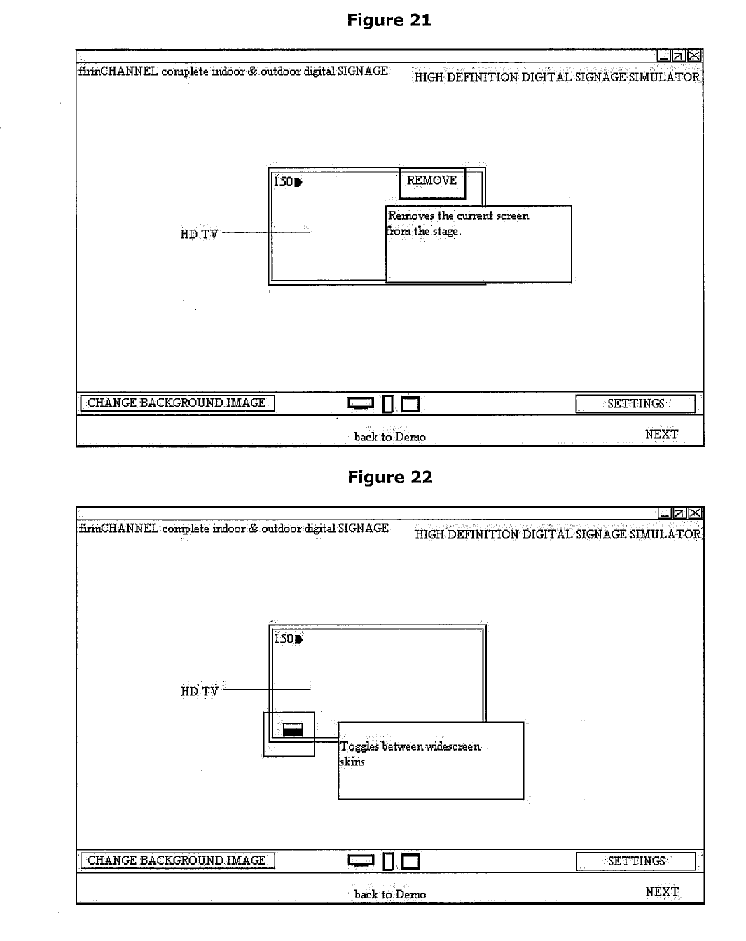

Referring to FIG. 21, a screen shot is provided of the high definition signage simulator depicting a user selecting to remove the current simulated digital signage display module from the current screen. FIG. 22 depicts a screen shot of another embodiment of high definition signage simulator where the user selects a toggle function that produces various skins of the simulated digital signage display.

The simulated digital signage display module may display a single stagnant image, such that the display never changes, or the simulated digital signage display may cycle through content in the same manner as the actual digital signage display would while playing a schedule of content. FIG. 23 depicts a screen shot of a user selecting to play a video on a simulated digital signage display that is placed over a backdrop of a shopping environment. In this embodiment, when the user selects the play feature, the simulated digital signage display module will cycle through content featuring animations, effects, videos and images. The user may cease the cycling of the display by selecting a pause feature on the simulated digital signage display module, which will cause the simulated digital signage display module to display a stagnant image.

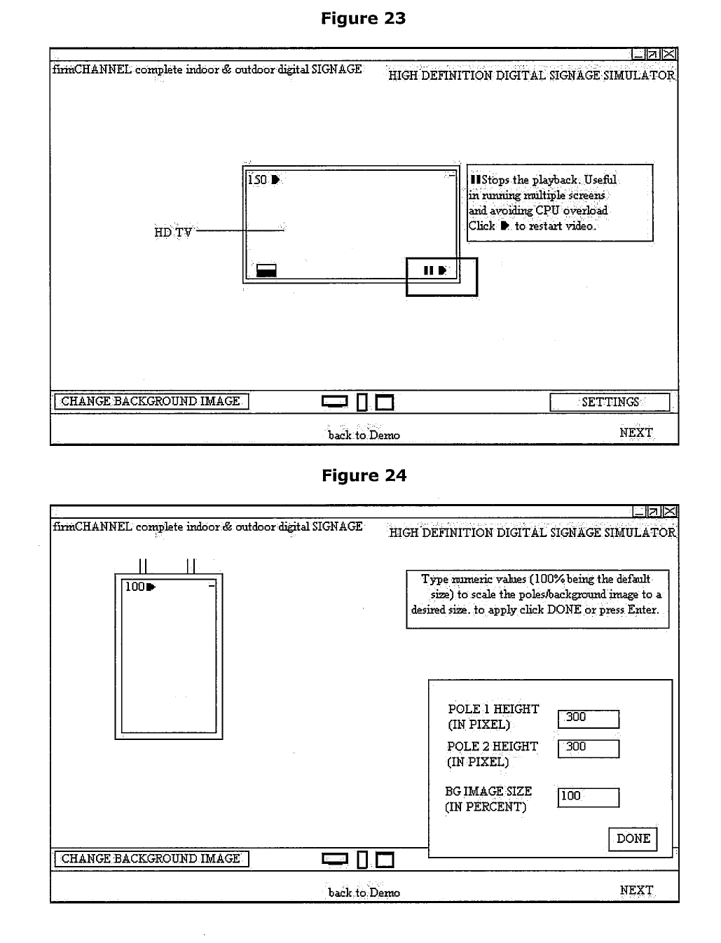

The simulated digital signage display module may take any shape or form according to the user's preference. For example, FIG. 24 depicts a screen shot where the simulated digital signage display module is longer vertically than its width. Further, additional images may be introduced onto the screen via the high definition signage simulator. FIG. 24 depicts a user selecting to add structural elements, two poles, to provide a simulated view of a hanging digital signage display. The user selects the pixel height of each pole via a window as depicted on the bottom right corner of the screen in FIG. 24.

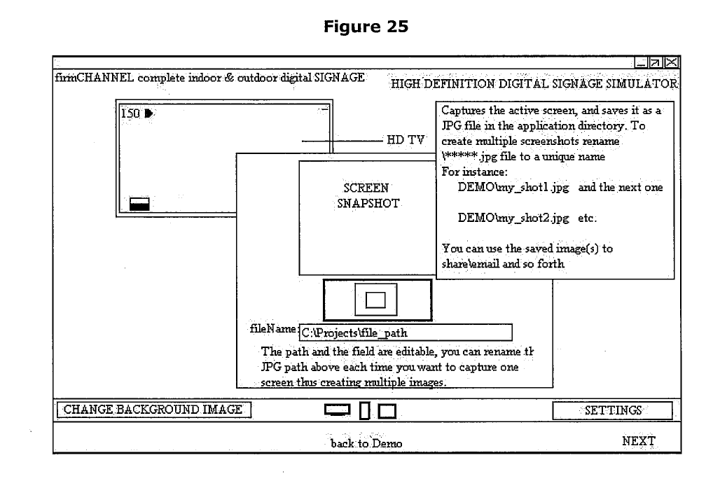

The high definition digital signage simulator also provides screen capture feature that allows the user to save as an image file the high definition signage simulator environment produced. FIG. 25 depicts the user saving as an image the environment created with a simulated digital signage display module upon a backdrop of a shopping environment.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A browser based user interface for designing and managing content for display on a digital signage network, said interface comprising:
a. a template community feature that provides an array of display templates for user selection;
b. a photo editing feature for modifying the appearance of electronic images, said photo editing feature comprising at least one of a cropping function, an effect modification function and a text overlay function; and
c. a logo manager feature for providing access to an array stored electronic logo images;
wherein said browser based user interface, when operated by a user, generates at least one digital scheduling program for operation on a digital signage network.

2. The browser based user interface of claim 1, wherein said interface is accessible via the internet.

3. The browser based user interface of claim 1, wherein said photo editor feature comprises a cropping function, an effect modification function and a text overlay function.

4. The browser based user interface of claim 1, further comprising a news management feature, wherein said news management feature provides external internet feeds for display on said digital signage network.

5. The browser based user interface of claim 1, further comprising a live access feature allowing a user to authenticate and access the creation content console remotely using the internet.

6. The browser based user interface of claim 1, wherein said interface further comprises a video playback feature for displaying video media via a digital signage system.

7. The browser based user interface of claim 1, wherein said digital display program comprises a plurality of media playlists.

8. The browser based user interface of claim 7, wherein said interface further comprises a granular scheduling feature for scheduling the display of said media playlists according to user specifications.

9. The browser based user interface of claim 1, wherein said interface further comprises a dynamic template feature enabling a user to create dynamic content.

10. A digital signage network for displaying a digital scheduling program, said digital signage network comprising:
a. a browser based user interface accessible on a computer work station for designing and editing the digital scheduling program, the browser based user interface comprising:
i. a template community feature providing an array of advertising content templates for user selection;
ii. a photo editor feature for modification of electronic images, the photo editor feature comprising at least one of a cropping function, an effect modification function and a text overlay function;
iii. a news management feature for providing external internet feeds for display on the digital scheduling program;
iv. a logo manager feature for providing access to an array electronic logo images;
v. a dynamic template feature enabling a user to create dynamic content on the digital scheduling program; and
vi. a granular scheduling feature for scheduling the display of the digital scheduling program according to user specifications;
b. a management center for managing the display of said digital scheduling program;
c. at least one media player for operating said digital scheduling program; and
d. at least one digital display unit,
wherein the browser based user interface, when operated by a user, generates and edits the digital scheduling program, the management center manages the display of the digital scheduling program according to user specifications provided via said browser based user interface, the digital scheduling program is operated by at least one media player for display on the at least one digital display unit.

11. The digital signage network of claim 10, wherein the browser based user interface further comprises a live access feature allowing a user to authenticate and access the browser based user interface remotely.

12. The digital signage network of claim 10, wherein the management center manages the display of the digital scheduling program according to user specifications provided via the granular scheduling feature of the browser based user interface.

13. The digital signage network of claim 10, wherein the browser based user interface is accessible via the internet.

14. The digital signage network of claim 13, wherein the content creation work station, the management center and at least one media player are in communication via the internet.

15. The digital signage network of claim 10, wherein the digital scheduling program comprises a plurality of digital media playlists.

16. The digital signage network of claim 10, comprising at least two thousand media players.

17. A digital signage simulator program comprising:
a. A simulated digital signage display module creation feature;
b. A background scene selection feature;
c. A simulated digital signage display module locator function; and
d. A structural image producing feature;
Wherein a user may create and control simulated digital signage display module using the simulated digital signage display module creation feature a scene, create a scene by adding a background image using the background scene selection feature and displace the simulated digital signage display module using the simulated digital signage display locator function.
